(19) United States
(12) Patent Application Publication
(10) Pub. No.: US 2012/0256426 A1
(43) Pub. Date: Oct. 11, 2012

(54) Drive Train and Wind Turbine

(75) Inventors: Andreas Klein, Aachen (DE); Andreas Vath, Leidersbach (DE); Klaus Noller, Oppenweiler (DE); Günter Berger, Castrop-Rauxel (DE); Burkhard Stadler, Witten (DE)

(73) Assignee: Robert Bosch GmbH, Stuttgart (DE)

(21) Appl. No.: 13/500,584

(22) PCT Filed: Jul. 31, 2010
(86) PCT No.: PCT/EP2010/004701

§ 371 Date: Jun. 26, 2012

(30) Foreign Application Priority Data
Oct. 8, 2009 (DE) 10 2009 048 766.2

(51) Int. Cl. F03D 11/02; H02K 7/116

(52) U.S. Cl. 290/1 C; 290/55

(57) ABSTRACT

A drive train for harnessing the energy of a fluid flow includes a rotor configured to be driven by the fluid flow, a transmission that is connected to the rotor at the input end, either directly or indirectly via the rotor shaft or other components, and a generator that is connected to the transmission at the output end. A lubricant system supplies lubricant to one of the drive train components as well as to another drive train component.

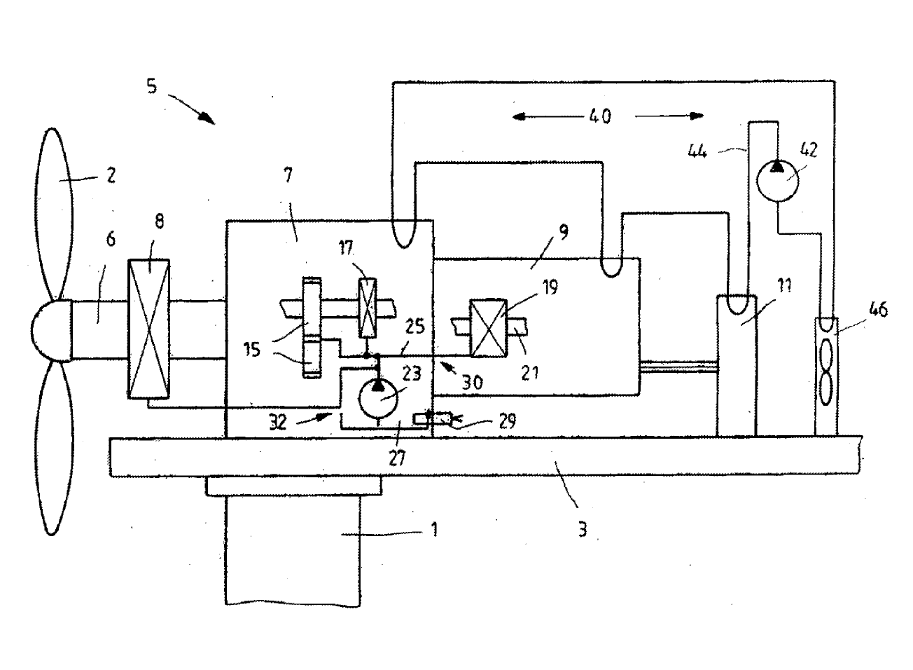

The present invention relates to a drive train for converting the energy of a fluid flow into electrical energy, i.e. to a drive train that could be used, for example, in a wind turbine in accordance with the preamble of claim 1. The present invention relates moreover to a wind turbine having a drive train of this type.

The numerous components of the drive train in a wind turbine require a supply of auxiliary fluid to ensure that the wind turbine functions properly. For example, transmissions, in particular the bearing and the gear wheels, but also bearings outside the transmission are often supplied with a lubricant, e.g. oil, to ensure a low-wear and low-loss running operation. It is also known to use a cooling fluid circuit for cooling the transmission and generator.

WO 2009/049599 A2 discloses a wind turbine, wherein a transmission and a generator are flange mounted one to the other by their housings. Cooling channels of the generator and cooling channels of the transmission are mutually connected by way of an intermediate plate.

Known wind turbines use of separate lubrication systems for different drive train components, such as a rotor bearing, a transmission, a generator, with respect to the functional components. This produces a highly complex drive train and the associated high costs.

Based on the prior art, the object of the present invention is to provide a drive train having a simple and efficient lubrication system.

This object is achieved by virtue of a drive train having the features of claim 1.

In the case of a drive train in accordance with the invention for harnessing the energy of a fluid flow, e.g. in a wind turbine, there are provided: a rotor that can be driven by the fluid flow, a transmission that is connected on the input side directly or also indirectly by way of the rotor shaft or other components to the rotor and a generator that is connected to the transmission on the output side. In accordance with the invention a lubrication system is provided that supplies not only any one of the drive train components itself but rather a further drive train component. As a consequence, the drive train can be achieved in a more cost-effective and more efficient manner. If, for example, the transmission is equipped with a lubrication system, then bearings that are arranged outside the transmission or other lubrication sites can be connected to this lubrication system at little cost. A reliable and low-wear drive train is achieved at little cost.

Advantageous embodiments are subject of the subordinate claims.

Preferably the individual lubrication sites are supplied in parallel. For example, it can be ensured that sufficient lubricant pressure prevails at each lubrication site.

A lubrication circuit of this type requires preferably only one pump. However, it is possible, for example, to provide a dedicated pump for each lubrication site, which pumps do, however, take in lubricant, for example, from a common sump. In addition, a plurality of pumps can be arranged as redundant lubricant delivery devices in parallel for the purpose of supplying highly available lubricant. This is particularly advantageous for offshore wind turbines as, in the case of wind turbines of this type, due to the high maintenance costs, the aim is to shorten the maintenance schedules.

When using internal channels of the housing for the lubricant, it is possible to convey the lubricant directly onwards between mutually flange-connected components by virtue of orifices arranged, for example, opposite the contact faces without having to provide, for example, any hoses or pipes.

A sump of the transmission housing can be used advantageously as a single lubricant reservoir in the lubrication circuit. This sump can be in thermal contact with a heating element in order to bring the transmission and other lubrication sites rapidly to the operating temperature in cold weather.

The invention is explained in further detail hereinunder with reference to a preferred exemplary embodiment with the aid of the accompanying drawing.

The single FIGURE illustrates the schematic construction of a drive train of a wind turbine having a cooling system in accordance with the present invention.

The FIGURE illustrates the drive train 5 of a wind turbine mounted on a carrier plate 3 that in turn is fastened to a tower 1 in such a manner as to be able to rotate about an azimuth axis. The carrier plate 3 is a component of a pod in which the components of the drive train 5 are structurally integrated. The drive train 5 comprises a rotor 2 that is driven by the wind. The rotor 2 is fastened to a rotor shaft 6 by means of a rotor hub. The shaft 6 of the rotor 2 is mounted in a bearing block 8 and guided onwards into a transmission 7. A generator 9 is flange mounted to the transmission 7. The transmission 7 and the generator 9 are connected to the carrier plate 3 by way of fastening devices, e.g. pins, brackets etc. A frequency converter 11 is electrically connected to the generator 9. The frequency converter 11 controls the generator 9 and supplies electrical energy to the electric network.

Gear wheels 15 from planetary gear stages or spur gear stages are provided in the transmission 7. In addition, bearings 17 for gear wheel studs, hollow wheels or gear shafts are provided. These gear wheels and bearings are illustrated schematically in the FIGURE as lubrication sites. The generator 9 also comprises bearings 19 for the generator shaft 21 that require lubricating.

A lubricating system 32 comprises a lubrication pump 23 that is installed in the transmission housing or mounted on the transmission housing. The lubrication pump 23 conveys lubricant, e.g. transmission oil, into the lubrication channels 25. The lubrication channels 25 distribute the lubricant in parallel to the said lubrication sites 15, 17, 19 and to the bearing block 8. Any returning lubricant is collected by way of channels (not illustrated) and returned to the sump 27 of the transmission housing.

A heating element, e.g. an electric heating rod 29, is arranged in the housing of the transmission 7 and in thermal contact with the sump 27. The said heating element can be used in cold weather to bring the transmission oil up to the operating temperature. In addition, the lubrication system distributes the heat by way of lubrication channels 25 to the other lubrication sites also outside the transmission 7, e.g. to the bearings 8 and 19 and ensures a low-wear operation of the drive train 5.

Alternatively the transmission 7 can be embodied without a sump. In that case, an external lubricant tank would be provided in place of the sump 27 and the lubrication pump 23 would take in lubricant from this container.

A lubrication channel in the flange area 30 between the transmission 7 and the generator 9 issues from the housing of the transmission 7 directly into the housing of the generator 9. Seals (not illustrated in the FIGURE) are arranged between the housings and as a consequence pipes or hoses are not required. This type of lubrication channel system can also be installed between the transmission 7 and the bearing 8 if a bearing of the rotor shaft 6 is flange mounted directly to the transmission housing.

A cooling system 40 is provided as a further auxiliary fluid system in addition to the lubrication system 32. The cooling system 40 comprises a cooling medium pump 42 that conveys a cooling fluid, e.g. water, glycol or a cooling medium by way of a cooling medium circuit or a cooling medium line 44. The cooling medium line 44 is connected one after the other to the heat exchanger elements of the frequency converter 11, of the generator 9 and of the transmission 7. The said components 11, 9 and 7 are connected in series in the cooling medium circuit. On the return run, downstream of the transmission 7, the cooling medium line 44 passes through a cooler 46 in which the circulating cooling medium is cooled and as a consequence the heat in the components 11, 9 and 7 introduced into the cooling medium is discharged by the said cooler to the environment, preferably to the air outside the pod. The cooler 46 can comprise a fan. It can also or rather alternatively be embodied with a cooling rib structure for a passive heat discharge.

The heat exchanger element in the frequency converter 11 can be a cooling plate to which, for example, power semiconductors are thermally coupled. A cooling channel structure of a stator winding or rather a carrier of the stator winding can be used as a heat exchanger element in the generator 9. In the transmission 7 a housing periphery or an oil cooler can be connected to the cooling circuit as a heat exchanger element.

The sequence of the components 11, 9 and 7 in the series connection of the cooling circuit depends upon the maximum operating temperature that the components can tolerate during the operation. Generally, electronic or rather power electronic components such as the frequency converter 11 are more sensitive to high operating temperatures than electro-mechanical or mechanical components such as the generator 9 or the transmission 7. Therefore, the sequence in the cooling medium circuit is the frequency converter 11, the generator 9 and finally the transmission 7. However, the sequence can be changed within the scope of the specification of the components.

The cooling medium line 44 can be directed through channels in the housing of the respective components, e.g. in the generator housing or in the transmission housing. If, for example, the components 7 and 9 are flange mounted one to the other, orifices can be provided that are arranged in the flange area and lying opposite on adjacent-lying housing end surfaces of the transmission 7 and the generator 9 and sealed by means of a seal against a gap between the housings. As a consequence, cooling medium can be conveyed from a housing channel into a channel of the other housing without having to provide any piping.

In the case of a drive train in accordance with the invention for harnessing the energy of a fluid flow, e.g. in a wind turbine, there are provided: a rotor that can be driven by the fluid flow, a transmission that is connected on the input side directly or also indirectly by way of the rotor shaft or other components to the rotor and a generator that is connected to the transmission on the output side. In accordance with the invention a lubrication system is provided that supplies not only any one of the drive train components itself but also a further drive train component. As a consequence, the drive train can be achieved in a more cost-effective and more efficient manner. If, for example, the transmission is equipped with a lubrication system, then bearings that are arranged outside the transmission or other lubrication sites can be connected to this lubrication system at little cost. A reliable and low-wear drive train is achieved at little cost.

The previously described exemplary embodiments and figures are used merely to improve the understanding of the present invention; they do not limit the invention to the exemplary embodiments. The figures are kept in part roughly schematic, the effect or the effects are partly clearly enlarged or exaggerated to illustrate clearly the operating modes, the operating principles, the technical embodiments and features. Fundamentally, each operating mode, each principle, each technical embodiment and each feature that is/are illustrated in the figures or in the text can be freely and optionally combined with all the claims, with each feature in the text and in the other figures, with other operating modes, principles, technical embodiments and features that are included in this disclosure or are evident from this disclosure, so that all feasible combinations are included in the scope of the disclosure of the invention. In so doing, also included are combinations between all individual embodiments in the text, i.e. in each section of the description text, in the claims and also combinations between different exemplary embodiments in the text, in the claims and in the figures.

The claims also do not restrict or limit the disclosure and as a consequence do not restrict or limit the possible combinations of all illustrated features. All illustrated features are explicitly included in the disclosure both individually and in combination with all other features of the invention.

1. A drive train configured to harness the energy of a fluid flow, comprising:
a rotor configured to be driven by the fluid flow;
a transmission that is connected on an input side to the rotor;
a generator connected to the transmission on an output side; and
a lubrication system configured to supply the transmission with a lubricant,
wherein the transmission is a drive train component, and
wherein at least one further drive train component can be supplied with the lubricant by the lubrication system.

2. The drive train as claimed in claim 1, wherein the transmission and the at least one further drive train component are connected in parallel with respect to a lubrication circuit.

3. The drive train as claimed in claim 2, wherein the lubrication circuit comprises a single lubricant delivery device.

4. The drive train as claimed in claim 2, wherein the lubrication circuit comprises a plurality of lubricant delivery devices, in particular in a parallel or a serial arrangement, in particular in a redundant arrangement, in particular pumps, for the lubricant.

5. The drive train as claimed in claim 1, wherein:
bearings for the rotor and/or bearings for an output shaft of the rotor and/or bearings for a connecting shaft between the transmission and the generator and/or the generator are provided as further drive train components, and
that bearings of this type or rather drive train components are supplied with lubricant by the lubrication system.

6. The drive train as claimed in claim 1, wherein in a housing of the transmission a sump is embodied as a reservoir, for the lubrication system.

7. The drive train as claimed in claim 6, wherein a lubrication oil pump of the lubrication system is arranged in the housing or on the housing of the transmission.

8. The drive train as claimed in claim 6, wherein a heating element is thermally connected to the sump and is arranged in the housing of the transmission.

9. The drive train as claimed in claim 1, wherein the lubricant can be delivered to a bearing of a shaft in the generator by virtue of the lubrication system.

10. The drive train as claimed in claim 1, wherein:
a housing of the transmission and a housing of the generator are flange mounted one to the other, and
lubrication channels issue into the respective flange area of the housing, which lubrication channels are arranged in such a manner that they allow lubricant to be conveyed from one housing to the other housing.

11. A wind turbine, comprising:
a drive train configured to harness energy of a fluid flow including (i) a rotor configured to be driven by the fluid flow, (ii) a transmission that is connected on an input side to the rotor, (iii) a generator connected to the transmission on an output side, and (iv) a lubrication system configured to supply the transmission with a lubricant,
wherein the transmission is a drive train component, and
wherein at least one further drive train component can be supplied with the lubricant by the lubrication system.
